(19) United States
(12) Patent Application Publication
(10) Pub. No.: US 2021/0031185 A1
(43) Pub. Date: Feb. 4, 2021

(54) MICROFLUIDIC DEVICES

(71) Applicant: Hewlett-Packard Development Company, L.P., Spring, TX (US)

(72) Inventors: Alexander Govyadinov, Corvallis, OR (US); Chantelle Domingue, Palo Alto, CA (US); Paul A. Richards, Corvallis, OR (US); Tommy D. Deskins, Corvallis, OR (US)

(73) Assignee: Hewlett-Packard Development Company, L.P., Spring, TX (US)

(21) Appl. No.: 16/965,702

(22) PCT Filed: Mar. 13, 2018
(86) PCT No.: PCT/US2018/022132

§ 371 Date: Jul. 29, 2020

(51) Int. Cl. B01L 3/00; G01N 35/10

(52) U.S. Cl. CPC B01L 3/50273; G01N 35/1009; G01N 2035/1034; B01L 2400/0415; B01L 2400/0487; B01L 2400/0475; B01L 2200/0684

(57) ABSTRACT

A method of operating a microfluidic device may include activating a fluid ejection actuator to eject an amount of fluid from a fluid ejection chamber through a nozzle, and activating a pump located within a micro-fluidic channel fluidically coupled to the fluid ejection actuator during a fluid ejection event to create a positive net flow from the pump to the fluid ejection chamber. The fluid ejection event may include a plurality of ejections of fluid from the nozzle.

### BACKGROUND

Microfluidic principles and associated microfluidic devices may be applied and used across a variety of disciplines including engineering, physics, chemistry, microtechnology and biotechnology. Microfluidics involves the study of small volumes, e.g., microliters, picoliters, or nanoliters, of fluid and how to manipulate, control, and use such small volumes of fluid in various microfluidic systems and devices such as microfluidic devices or chips.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a microfluidic device, according to an example of the principles described herein.

FIG. 2 is a flowchart showing a method of operating a microfluidic device, according to an example of the principles described herein.

FIG. 3 is a flowchart showing a method of operating a microfluidic device, according to another example of the principles described herein.

FIG. 4 is a block diagram of a microfluidic device, according to yet another example of the principles described herein.

FIG. 5 is a block diagram of a microfluidic device, according to still another example of the principles described herein.

FIG. 6 is a block diagram of a microfluidic device, according to yet another example of the principles described herein.

FIG. 7 is a block diagram of a microfluidic device, according to yet another example of the principles described herein.

FIG. 8 is a flowchart showing a method of operating a microfluidic device, according to another example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Microfluidic biochips, which may also be referred to as a “lab-on-chip,” may be used in the field of molecular biology to integrate assay operations for purposes such as analyzing enzymes and deoxyribonucleic acid (DNA), detecting biochemical toxins and pathogens, diagnosing diseases, and perform other chemical and physical analysis of an analyte

As fluid is moved within a microfluidic device, bubbles of air may be formed. This may occur when the fluid is being ejected from the microfluidic device via an actuator and nozzle. The air bubbles may be trapped in microfluidic channels. Further, the air bubbles may be trapped in and around pumps used to pump fluid through the microfluidic channels and in and around fluid ejection chambers where an actuator used to eject fluid from the ejection chamber is located.

The air bubbles may cause the microfluidic device to operate in an unintended or deficient manner. Recirculation of fluid in the microfluidic channels may be used to reduce decapping issues that may occur. With or without a system that may exhibit decapping issues, when a fluid moved within and/or ejected from the microfluidic device remains stagnant, particles such as, for example, components within an ink, begin to separate from a fluid vehicle. As the fluid vehicle evaporates viscous plug formation may occur such that fluid ejection performance may be reduced or disabled for the microfluidic device. Fluid micro-recirculation (μ-recirculation) may correspond to fluid movement and/or currents periodically established in various directions in the respective microfluidic channels within the microfluidic device to reduce viscous plug formation.

However, some microfluidic channels can entrap air bubbles generated by activation of an actuator such as a thermal fluid ejection resistor. Entrapment of such air bubbles may lead to de-priming of a pump used to create μ-recirculation within the microfluidic device and may also result in de-priming of the actuator used to eject fluid from the fluid ejection chamber. Specifically, the activation of a fluid ejection actuator vaporizes the fluid and creates a steam bubble and subsequent collapse of that steam bubble. The generation and collapse of the steam bubble produces small remnant air bubbles from air which was dissolved in an evaporated portion of the fluid such as an ink. The activation of a fluid ejection actuator creates a pumping effect and moves the remnant bubble towards the pump via micro-fluidic channel. Multiple firing events may produce bigger air bubbles due to combining multiple remnant bubble into one larger air bubble. If a larger air bubble exceeds a certain size, the air bubble may become self-sustaining at given operational conditions including certain levels of air super saturation in the fluid, temperature, humidity, and other operational conditions. Large air bubbles may correspond to pump and nozzle de-prime issues that may decrease print quality and an increase transient nozzle failure.

To mitigate these issues, a number of air bubble tolerating structures may be added to restrain air bubble propagation from the fluid ejection chamber to an area around the pump. However, manufacturing these air bubble tolerating structures is complicated and expensive.

Examples described herein provide a method of operating a microfluidic device. The method may include activating a fluid ejection actuator to eject an amount of fluid from a fluid ejection chamber through a nozzle, and activating a pump located within a micro-fluidic channel fluidically coupled to the fluid ejection actuator during a fluid ejection event to create a positive net flow from the pump to the fluid ejection chamber. The fluid ejection event may include a plurality of ejections of fluid from the nozzle.

The pump may be activated following every activation of the fluid ejection actuator, activated a plurality of times following every activation of the fluid ejection actuator, following two activations of the fluid ejection actuator, or following at least three activations of the fluid ejection actuator. The fluid ejection actuator may be activated following every activation of the pump, following activation of the fluid ejection actuator in a variable manner. The pump and fluid ejection actuator may be activated based on a combination of the activation operations described above and herein.

In some examples, the frequency of the activation of the pump may be identical to a frequency of the activation of the fluid ejection actuator. In other examples, the frequency of the activation of the pump may be different from a frequency of the activation of the fluid ejection actuator. In one example, the ratio of the frequency of the activation of the pump with respect to the frequency of the activation of the fluid ejection actuator is between 3:1 and 1:100. In another example, the ratio of the frequency of the activation of the pump with respect to the frequency of the activation of the fluid ejection actuator is between 1000:1 and 1:1000. Examples provided herein may further include activating the pump before the fluid ejection event, during the fluid ejection event, after the fluid ejection event, or combinations thereof. The micro-fluidic channel fluidically coupling the fluid ejection chamber and the pump may be formed with the microfluidic device in a u-shape, a w-shape, an m-shape, a T-shape, an I-shape, an S-shape, or combinations thereof.

Examples described herein also provide a microfluidic device. The microfluidic device may include a fluid ejection actuator to eject an amount of fluid from a fluid ejection chamber through a nozzle, a pump located within a micro-fluidic channel fluidically coupled to the fluid ejection chamber, and activation logic. The activation logic may activate the fluid ejection actuator, and activate the pump during a fluid ejection event to create a positive net flow from the pump to the fluid ejection chamber. The fluid ejection event may include a plurality of ejections of fluid from the nozzle.

The activation logic may further activate the pump following every activation of the fluid ejection actuator, activate the pump a plurality of times following every activation of the fluid ejection actuator, activate the pump following two activations of the fluid ejection actuator, activate the pump following at least three activations of the fluid ejection actuator, activate the fluid ejection actuator following every activation of the pump, activate the pump following activation of the fluid ejection actuator in a variable manner, or combinations thereof. The micro-fluidic channel fluidically coupling the fluid ejection chamber and the pump may be formed with the microfluidic device in a u-shape, a w-shape, an m-shape, a T-shape, an I-shape, an S-shape, or combinations thereof. The pump may include a thermal resistor. The microfluidic device may include a plurality of fluid ejection actuators within a corresponding number of fluid ejection chambers fluidically coupled to a plurality of pumps, and a plurality of micro-fluidic channels fluidically coupling each one of the fluid ejection chambers to the pumps.

Examples described herein also provide a method of operating a microfluidic device. The method may include, activating a fluid ejection actuator to eject an amount of fluid from a fluid ejection chamber through a nozzle, and activating a pump located within a micro-fluidic channel fluidically coupled to the fluid ejection chamber during a fluid ejection event to create a positive net flow from the pump to the fluid ejection chamber, the fluid ejection event comprising a plurality of ejections of fluid from the nozzle. A ratio of the frequency of the activation of the pump with respect to a frequency of the activation of the fluid ejection actuator may be defined by an efficiency of the pump to compensate for air bubbles formed by activation of the fluid ejection actuator purged from the nozzle towards the pump and micro-recirculation design geometry of the micro-fluidic channel.

In one example, the ratio of the frequency of the activation of the pump with respect to a frequency of the activation of the fluid ejection actuator is between 3:1 and 1:100. In another example, the ratio of the frequency of the activation of the pump with respect to the frequency of the activation of the fluid ejection actuator is between 1000:1 and 1:1000. The pump may be activated following activation of the fluid ejection actuator in a variable manner.

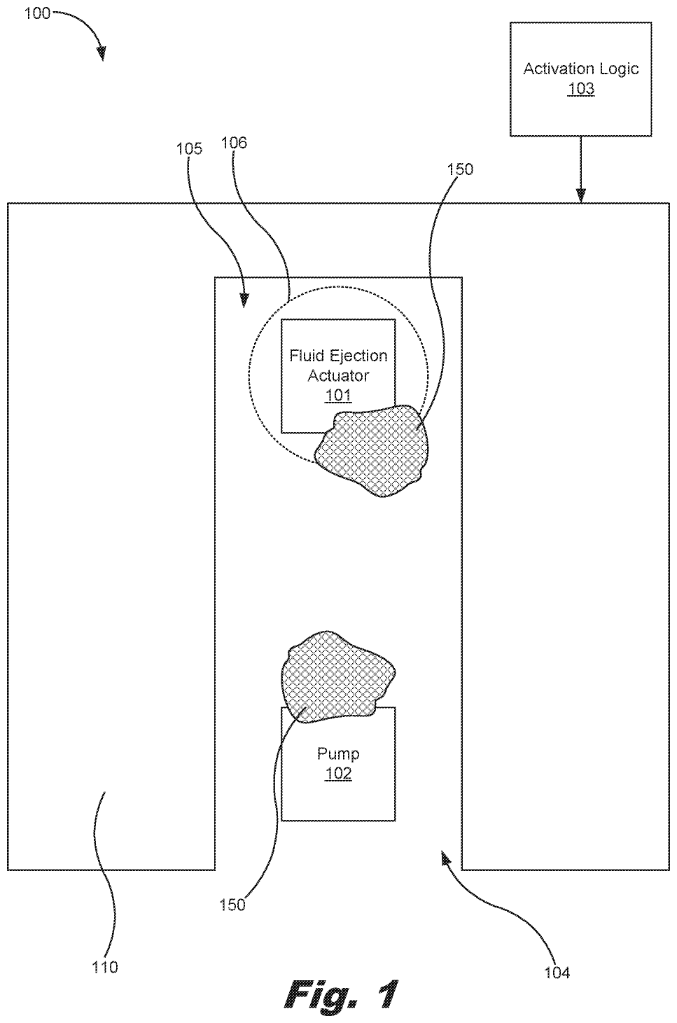

Turning now to the figures, FIG. 1 is a cross-sectional block diagram of a microfluidic device (100), according to an example of the principles described herein. The microfluidic device (100) may include a fluid ejection actuator (101) to eject an amount of fluid from a fluid ejection chamber (105) through a nozzle (106). In FIG. 1 and throughout similar figures, the nozzle (106) is depicted using dashed lines to indicate that the nozzle (106) is not shown in the cross-section, but is located above those elements depicted in the figure. A number of microfluidic channels (104) may be defined within a substrate (110) of the microfluidic device (100) to allow for fluid to flow to a number of pumps (102) and/or fluid ejection actuators (101) disposed within the microfluidic channels (104).

The fluid ejection actuator (101) may be any device that causes fluid within the fluid ejection chamber (105) to be ejected from the nozzles (106). In one example, the fluid ejection actuators (101) within the microfluidic device (100) may include thermal resistors to vaporize the fluid and create bubbles that force fluid out of nozzles (106). In another example, the microfluidic device (100) may include piezoelectric material actuators as an ejection element to generate pressure pulses that force the fluid out of nozzles (106). In still another example, the microfluidic device (100) may include actuators (101) that include magnetostrictive membranes, electrostatic membranes, mechanical actuators, other fluid displacement devices, or combinations thereof.

The microfluidic device (100) may also include a pump (102) located within a micro-fluidic channel (104) fluidically coupled to the fluid ejection actuator (101). The pumps (102) may be activated to move fluid through a number of microfluidic channels (104) defined in the microfluidic device (100) and towards the actuators (101). Like the fluid ejection actuators (101), the pumps (102) may be any device that causes fluid to flow within the channels (104). In one example, the pumps (102) within the microfluidic device (100) may include thermal resistors to vaporize the fluid and create bubbles that force fluid through the microfluidic channels (104). In another example, the microfluidic device (100) may include piezoelectric material actuators as an ejection element to generate pressure pulses that force the fluid through the channels (104). In still another example, the microfluidic device (100) may include pumps (102) that include magnetostrictive membranes, electrostatic membranes, mechanical actuators, other fluid displacement devices, or combinations thereof.

In one example, the microfluidic device (100) may include a plurality of fluid ejection actuators (101) within a corresponding number of fluid ejection chambers (105) fluidically coupled to a plurality of pumps (102). Thus, the number of fluid ejection actuators (101) may exceed the number of pumps (102) as long as there exists at least one pump (102) within a microfluidic channel (104) that also includes at least one fluid ejection actuator (101). Further, the microfluidic device (100) may include a plurality of micro-fluidic channels (104) fluidically coupling each one of the fluid ejection chambers (105) to the pumps (102) to allow for the pumps (102) to move fluid within the microfluidic channels (104) to the fluid ejection actuators (101).

As described herein, a number of air bubbles (150) may be generated during a number of fluid ejection events as the fluid ejection actuators (101) and the pumps (102) activate. This may be especially the case in examples where the fluid ejection actuators (101) and the pumps (102) are thermal resistive elements that vaporize the fluid and create bubbles that force fluid out of nozzles (106). These air bubbles may tend to collect within the microfluidic channels (104), around the pumps (102), in the fluid ejection chambers (105), and around the fluid ejection actuators (101). The formation of air bubbles in these areas of the microfluidic device (100) may cause a number of issues with the functionality of the microfluidic device (100).

For example, the presence of air bubbles (150) around the pumps (102) may cause the pumps (102) to become de-primed. De-priming of the pumps (102) exists where there is an absence of fluid on and around the pumps (102). If the air bubbles (150) exist around the pumps (102), the pumps (102) do not have fluid to either vaporize or push, and, therefore, no fluid is pushed through the microfluid channels (104) to the fluid ejection actuators (101).

Further, the presence of air bubbles (150) around the fluid ejection actuators (101) may cause the fluid ejection actuators (101) to become de-primed. De-priming of the fluid ejection actuators (101) exists where there is an absence of fluid on and around the fluid ejection actuators (101). If the air bubbles (150) exist around the fluid ejection actuators (101), the fluid ejection actuators (101) do not have fluid to vaporize within the fluid ejection chamber (105), and, therefore, no fluid is ejected from the nozzles (106).

Still further, the presence of air bubbles (150) within the fluid within the microfluidic channels (104) may result in the air bubbles (150) collecting around the fluid ejection actuators (101) and/or the pumps (102) resulting the de-priming of the fluid ejection actuators (101) and/or the pumps (102) described herein. When the fluid ejection actuators (101) and/or the pumps (102) become de-primed, that fluid ejection actuator (101) cannot properly eject the fluid form the microfluidic device (100) and the fluid is not dispensed as intended. For example, when the fluid is not dispensed as intended, a printed image that is being printed by the microfluidic device (100) may have a diminished print quality. In addition to the de-priming issue, a large enough air bubble located anywhere in the microfluidic channels (104) may create compliance in the system and may have a significant effect on both pumping of the fluid and the ejection of the fluid.

In order to reduce or eliminate air bubbles (150) within the microfluidic channels (104) of the microfluidic device (100), activation logic (103) may be included in or coupled to the microfluidic device (100) to activate the pumps (102) and the fluid ejection actuators (101) within the microfluidic channels (104). More specifically, the activation logic (103) may activate the fluid ejection actuators (101), and activate the pumps (102) during a fluid ejection event to create a positive net flow from the pumps (102) to the fluid ejection chamber (105). The fluid ejection event includes a plurality of ejections of fluid from the nozzles (106).

In one example, the activation logic (103) of the microfluidic device (100) may further activate the pump (102) at any time before, during, and after the fluid ejection event, or combinations thereof. For example, the activation logic (103) may activate the pump (102) following every activation of the fluid ejection actuator (101), activate the pump (102) a plurality of times following every activation of the fluid ejection actuator (101), activate the pump (102) following two activations of the fluid ejection actuator (101), activate the pump (102) following at least three activations of the fluid ejection actuator (101), activate the fluid ejection actuator (101) following every activation of the pump (102), activate the pump (101) following activation of the fluid ejection actuator (101) in a variable manner, or combinations thereof. In one example, activation of the pump (101) following activation of the fluid ejection actuator (101) in a variable manner may include any of the above activation processes in any order or frequency.

Activation of a pump (102) located within a micro-fluidic channel (104) fluidically coupled to the fluid ejection actuator (101) during a fluid ejection event creates a positive net flow from the pump (102) to the fluid ejection chamber (105) where the fluid ejection actuator (101) is located. This clears the air bubbles (150) from the microfluidic channels (104) such that the de-priming that may otherwise occur is reduced or eliminated during the firing event, and the fluid is consistently ejected from the nozzles (106).

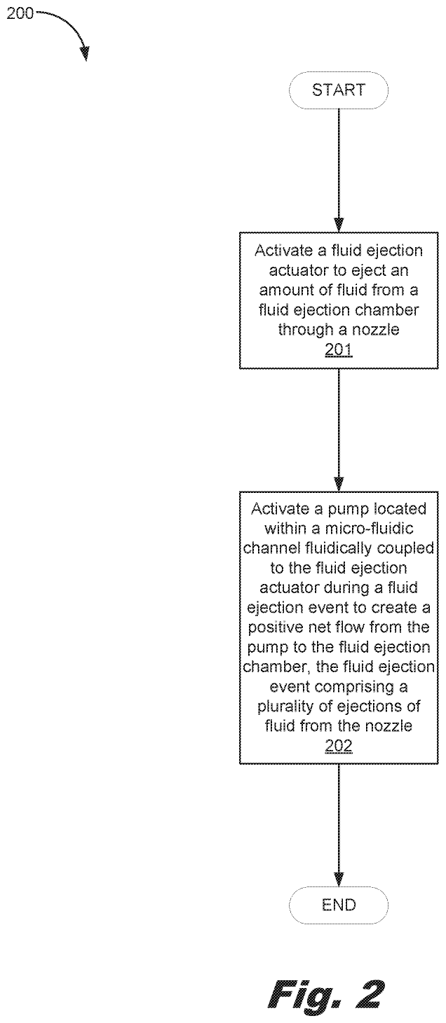

FIG. 2 is a flowchart showing a method (200) of operating a microfluidic device (100), according to an example of the principles described herein. The method (200) may include activating (block 201) a fluid ejection actuator (101) to eject an amount of fluid from a fluid ejection chamber (105) through a nozzle (106). A pump (102) located within a micro-fluidic channel (104) fluidically coupled to the fluid ejection actuator (101) may be actuated (block 202) during a fluid ejection event to create a positive net flow from the pump (102) to the fluid ejection chamber (105). The fluid ejection event includes a plurality of ejections of fluid from the nozzle (106).

In one example, the pumps (102) may be activated following every activation of the fluid ejection actuator (101), a plurality of times following every activation of the fluid ejection actuator (101), activated following two activations of the fluid ejection actuator (101), or activated following at least three activations of the fluid ejection actuator (101). Further, in one example, the fluid ejection actuator (101) may be activated following every activation of the pump (102). In another example, the pump is activated following activation of the fluid ejection actuator in a variable manner, or combinations thereof.

In another example a frequency of the activation of the pump (102) may be identical to a frequency of the activation of the fluid ejection actuator (101). In another example, the frequency of the activation of the pump (102) may be different from a frequency of the activation of the fluid ejection actuator. In this example, the ratio of the frequency of the activation of the pump (102) with respect to the frequency of the activation of the fluid ejection actuator (101) may be between 3:1 and 1:100. In another example, the ratio of the frequency of the activation of the pump with respect to the frequency of the activation of the fluid ejection actuator is between 1000:1 and 1:1000. Further, the activation of the pump (102) may occur before the fluid ejection event, during the ejection event, after the fluid ejection event, or combinations thereof.

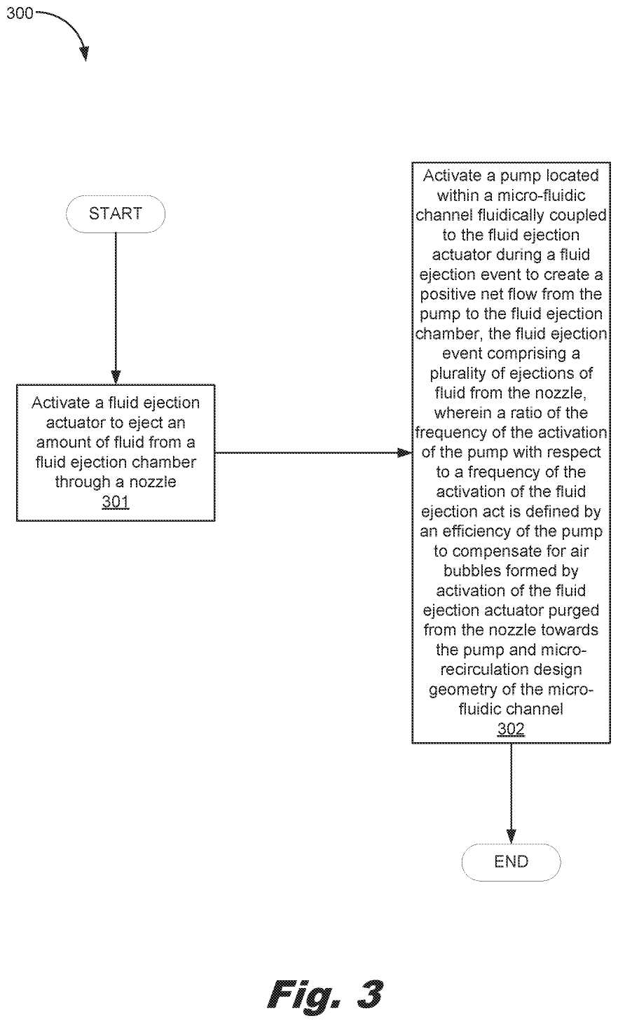

FIG. 3 is a flowchart (300) showing a method of operating a microfluidic device, according to another example of the principles described herein. The method (300) may include activating (block 301) a fluid ejection actuator (101) to eject an amount of fluid from a fluid ejection chamber (105) through a nozzle (106). A pump (102) located within a micro-fluidic channel (104) fluidically coupled to the fluid ejection actuator (101) may be actuated (block 302) during a fluid ejection event to create a positive net flow from the pump (102) to the fluid ejection chamber (105). The fluid ejection event includes a plurality of ejections of fluid from the nozzle (106) wherein the ratio of the frequency of the activation of the pump (102) with respect to a frequency of the activation of the fluid ejection actuator (101) is defined by an efficiency of the pump (102) to compensate for air bubbles formed by activation of the fluid ejection actuator (101) purged from the nozzle (106) towards the pump (102), and micro-recirculation design geometry of the micro-fluidic channel (104).

In one example, the ratio of the frequency of the activation of the pump with respect to a frequency of the activation of the fluid ejection actuator is between 3:1 and 1:100. In another example, the ratio of the frequency of the activation of the pump with respect to the frequency of the activation of the fluid ejection actuator is between 1000:1 and 1:1000. In one example, the pumps (102) may be activated following every activation of the fluid ejection actuator (101), a plurality of times following every activation of the fluid ejection actuator (101), activated following two activations of the fluid ejection actuator (101), or activated following at least three activations of the fluid ejection actuator (101). Further, in one example, the fluid ejection actuator (101) may be activated following every activation of the pump (102). In another example, the pump is activated following activation of the fluid ejection actuator in a variable manner, or combinations thereof.

In another example a frequency of the activation of the pump (102) may be identical to a frequency of the activation of the fluid ejection actuator (101). In another example, the frequency of the activation of the pump (102) may be different from a frequency of the activation of the fluid ejection actuator. Further, the activation of the pump (102) may occur before the fluid ejection event, after the fluid ejection event, or combinations thereof.

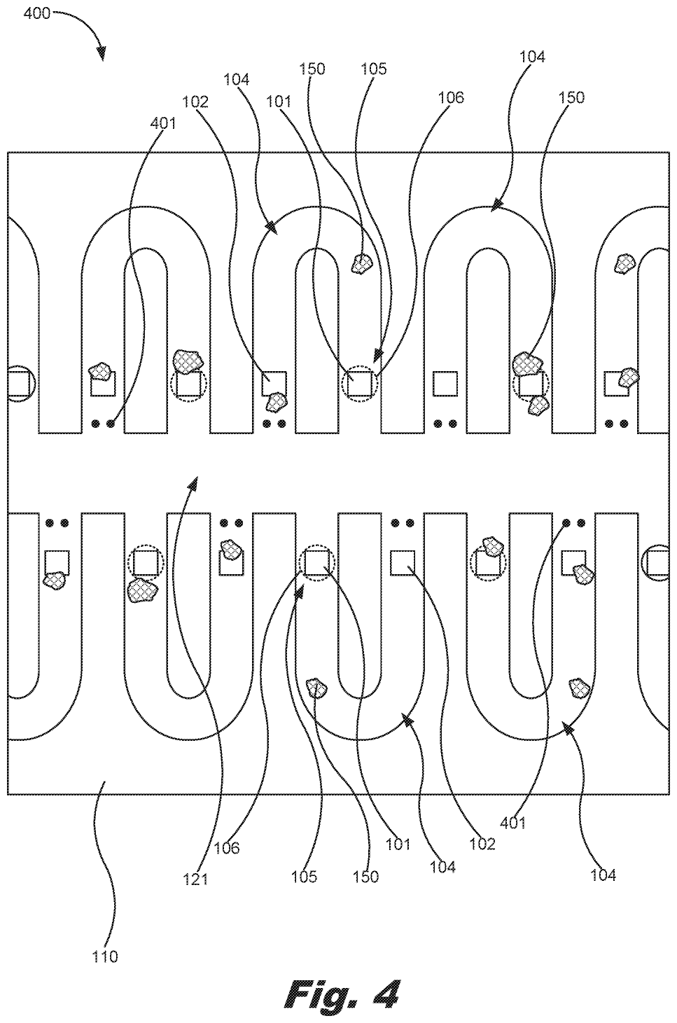

FIGS. 4 through 7 are block diagrams of the microfluidic device (100), according to yet another example of the principles described herein. The examples of FIGS. 4 through 7 depict microfluidic channels (104) of different micro-recirculation geometries. In FIG. 4, the microfluidic device (400) includes a number of u-shaped microfluidic channels (104) that include a pump (102) located in one leg of the u-shape, and the fluid ejection chamber (105), fluid ejection actuator (101) and nozzle (106) in the other leg of the u-shape. The pump (102) moves fluid toward the fluid ejection chamber (105) to allow the air bubbles (150) to be evacuated out of the microfluidic channels (104) and reduce or eliminate the possibility of de-priming the pump (102) and/or the fluid ejection actuator (101) as described herein. The examples of FIGS. 4 through 6 also include a number of posts (401) that serve to keep particles within the fluid out of the microfluidic channels (104).

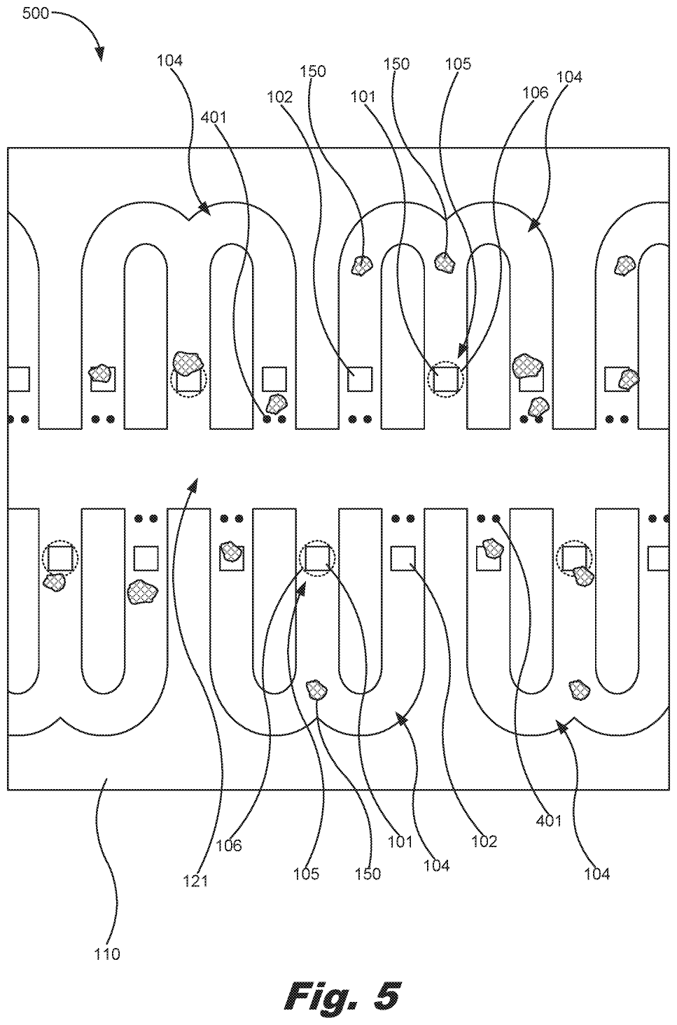

FIG. 5 is a block diagram of a microfluidic device (500) that includes m-shaped and w-shaped microfluidic channels (104). The architecture of the microfluidic channels (104) in the example of FIG. 5 allows for two pumps (102) located in two of the legs of the m-shaped and w-shaped microfluidic channels (104) to pump fluid to a fluid ejection actuator (101) located in the third leg. In another example of FIG. 5, the m-shaped and w-shaped microfluidic channels (104) may include a pump located in the middle leg of the m-shaped and w-shaped microfluidic channels (104), and two fluid ejection actuators (101) may be included in the other two legs of the m-shaped and w-shaped microfluidic channels (104).

In FIGS. 4 and 5, the air bubbles (150) may be pushed out of the microfluidic channels (104) and into a main channel (121) where the air bubbles (150) are restricted from moving back into the microfluidic channels (104) by the posts (401). Further, the air bubbles (150) may be pushed out of the microfluidic channels (104) through the nozzles (106) as the pump (102) may work in concert with the fluid ejection actuators (101) to push the air bubbles (150) out of the nozzles (106).

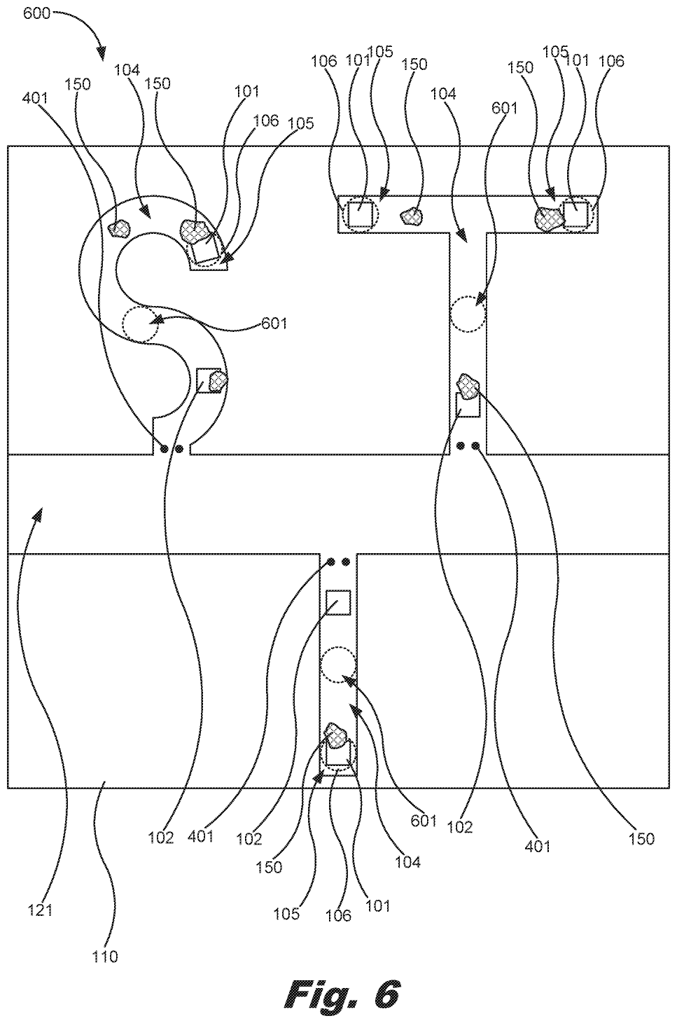

FIG. 6 is a block diagram of a microfluidic device (600) that includes an s-shaped microfluidic channel (104), a T-shaped microfluidic channel (104), and an I-shaped microfluidic channel (104). In examples of the microfluidic channels (104) in FIG. 6, because the microfluidic channels (104) do not empty back into the main channel (121) but, instead, terminate, the air bubbles (150) may be pushed out of the microfluidic channels (104) through the nozzles (106) as the pump (102) may work in concert with the fluid ejection actuators (101) to push the air bubbles (150) out of the nozzles (106).

In another example, the microfluidic channels (104) may not terminate, but may also include a number of fluid fed holes (601) formed above the microfluidic channels (104). These fluid feed holes (601) may allow for μ-recirculation to occur within the s-shaped microfluidic channel (104), T-shaped microfluidic channel (104), and I-shaped microfluidic channel (104) by providing an inlet from the main channel (121) and out the fluid feed holes (601).

The microfluidic channels (104) depicted in FIGS. 1, and 4 through 6 are examples of the varying micro-recirculation design geometries of the micro-fluidic channels (104). The microfluidic device (100) may include any number of different types of microfluidic channels (104) including u-shaped microfluidic channels, w-shaped microfluidic channels, m-shaped microfluidic channels, a T-shaped microfluidic channels, I-shaped microfluidic channels, an S-shaped microfluidic channels, or combinations thereof.

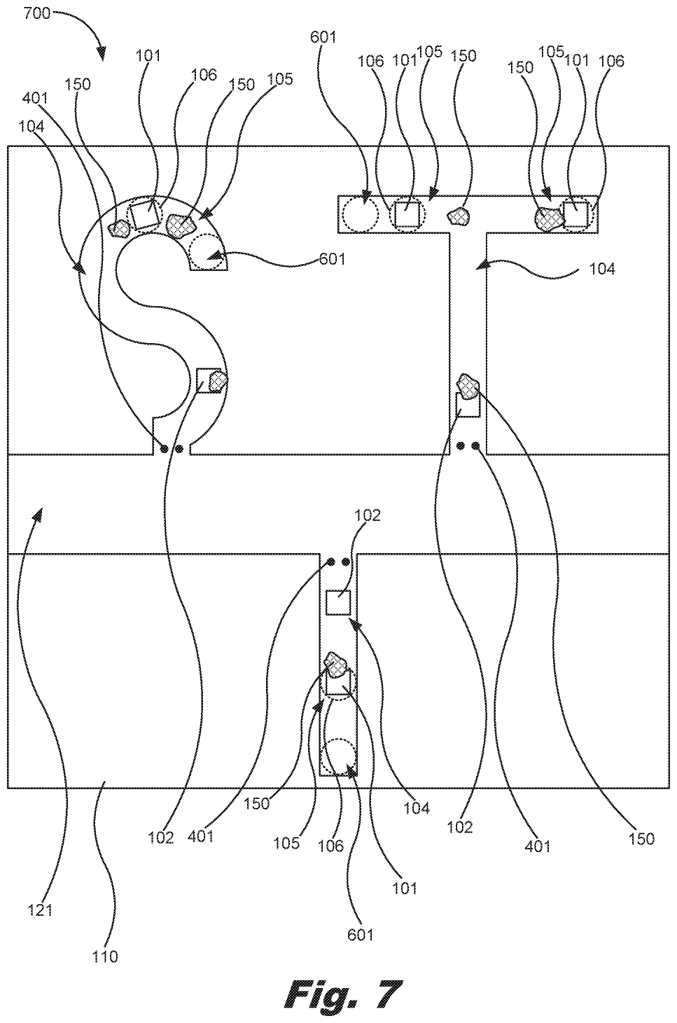

FIG. 7 is a block diagram of a microfluidic device (700), according to yet another example of the principles described herein. In the example of FIG. 7, the air bubbles (150) may be pushed out of the microfluidic channels (104) through the fluid feed holes (601) as the pump (102) may work in concert with the fluid ejection actuators (101). Specifically, the fluid feed holes (601) may be located downstream from the nozzles (106), fluid ejection actuators (101), and pumps (102) to enable air purging after the fluid is moved by the pumps (102) and past the fluid ejection actuators (101). As the fluid and air bubbles (150) are recirculated through the microfluidic device (700) via the fluid feed holes (601), the air bubbles (150) are purged from the microfluidic channels (104).

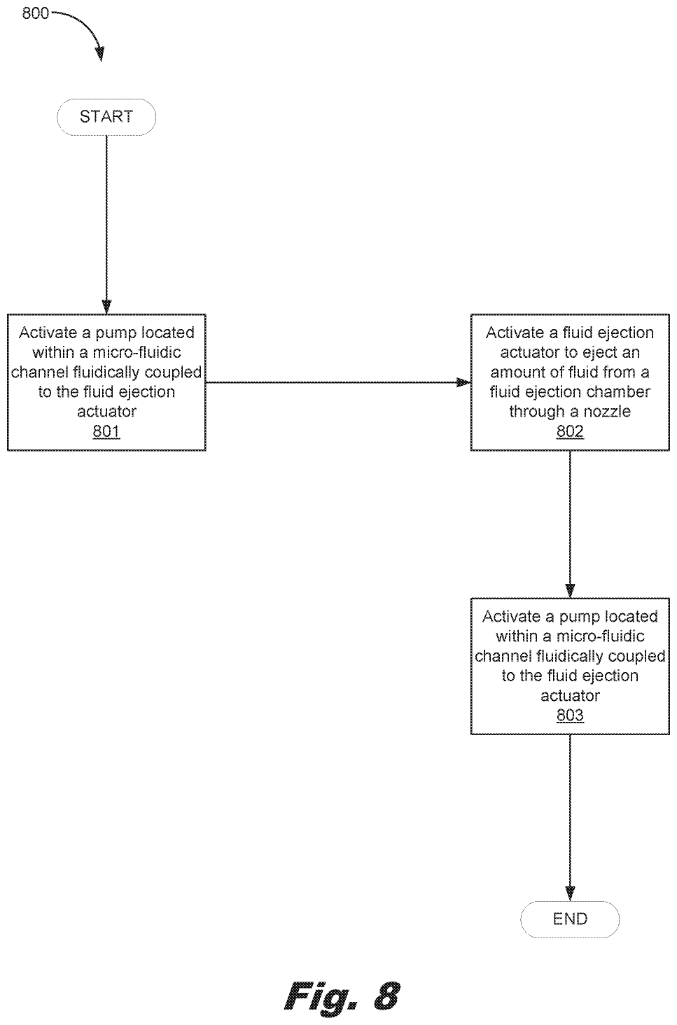

FIG. 8 is a flowchart showing a method (800) of operating a microfluidic device (100), according to another example of the principles described herein. The method (800) may include activating a pump (102) located within a micro-fluidic channel (104) fluidically coupled to the fluid ejection actuator (101) before activating (block 801) a fluid ejection actuator (101) that ejects an amount of fluid from a fluid ejection chamber (105) through a nozzle (106). This may create a positive net flow from the pump (102) to the fluid ejection chamber (105). In this example, the fluid ejection event may include a plurality of ejections of fluid from the nozzle (106). The pump (102) may be actuated (block 803) again after the fluid ejection event to create a positive net flow from the pump (102) to the fluid ejection chamber (105).

The specification and figures describe methods of operating a microfluidic device and associated devices. The method may include activating a fluid ejection actuator to eject an amount of fluid from a fluid ejection chamber through a nozzle, and activating a pump located within a micro-fluidic channel fluidically coupled to the fluid ejection actuator during a fluid ejection event to create a positive net flow from the pump to the fluid ejection chamber. The fluid ejection event may include a plurality of ejections of fluid from the nozzle.

The methods described herein and the associated devices provide for a sequence of activations of the pumps and fluid ejection actuators that enable a positive net-flow from pump-to-nozzle completely eliminating air entrapment in the micro-fluidic channel including nozzle and pump chambers during a fluid ejection event. Further, the methods described herein provide for the μ-recirculation of fluid within the microfluidic channels to correct decapping issues such as particle/vehicle separation and viscous plug formation while still allowing air bubbles generated by the activation of the pumps and fluid ejection actuators to be removed from the microfluidic channels and reducing or eliminating potential de-priming of the pumps and fluid ejection actuators.

The preceding description has been presented to illustrate and describe examples of the principles described. This description is not intended to be exhaustive or to limit these principles to any precise form disclosed. Many modifications and variations are possible in light of the above teaching.

What is claimed is:

1. A microfluidic device, comprising:
a fluid ejection actuator to eject an amount of fluid from a fluid ejection chamber through a nozzle;
a pump located within a micro-fluidic channel fluidically coupled to the fluid ejection actuator; and
activation logic to:
activate the fluid ejection actuator; and
activate the pump during a fluid ejection event to create a positive net flow from the pump to the fluid ejection chamber, the fluid ejection event comprising a plurality of ejections of fluid from the nozzle.

2. The microfluidic device of claim 1, wherein the activation logic further activates the pump following every activation of the fluid ejection actuator, activates the pump a plurality of times following every activation of the fluid ejection actuator, activates the pump following two activations of the fluid ejection actuator, activates the pump following at least three activations of the fluid ejection actuator, activates the fluid ejection actuator following every activation of the pump, activates the pump following activation of the fluid ejection actuator in a variable manner, or combinations thereof.

3. The microfluidic device of claim 1, wherein the micro-fluidic channel fluidically coupling the fluid ejection chamber and the pump is formed with the microfluidic device in a u-shape, a w-shape, an m-shape, a T-shape, an I-shape, an S-shape, or combinations thereof.

4. The microfluidic device of claim 1, wherein the pump comprises a thermal resistor, a piezoelectric element, a magnetostrictive membrane, an electrostatic membrane, or a mechanical actuator.

5. The microfluidic device of claim 1, comprising:
a plurality of fluid ejection actuators within a corresponding number of fluid ejection chambers fluidically coupled to a plurality of pumps; and
a plurality of micro-fluidic channels fluidically coupling each one of the fluid ejection chambers to the pumps.

6. A method of operating a microfluidic device, comprising:
activating a fluid ejection actuator to eject an amount of fluid from a fluid ejection chamber through a nozzle;
activating a pump located within a micro-fluidic channel fluidically coupled to the fluid ejection actuator during a fluid ejection event to create a positive net flow from the pump to the fluid ejection chamber, the fluid ejection event comprising a plurality of ejections of fluid from the nozzle.

7. The method of claim 6, wherein the pump is activated following every activation of the fluid ejection actuator, the pump is activated a plurality of times following every activation of the fluid ejection actuator, the pump is activated following two activations of the fluid ejection actuator, the pump is activated following at least three activations of the fluid ejection actuator, the fluid ejection actuator is activated following every activation of the pump, the pump is activated following activation of the fluid ejection actuator in a variable manner, or combinations thereof.

8. The method of claim 6, wherein a frequency of the activation of the pump is identical to a frequency of the activation of the fluid ejection actuator.

9. The method of claim 6, wherein a frequency of the activation of the pump is different from a frequency of the activation of the fluid ejection actuator.

10. The method of claim 9, wherein a ratio of the frequency of the activation of the pump with respect to the frequency of the activation of the fluid ejection actuator is between 1000:1 and 1:1000.

11. The method of claim 6, comprising activating the pump before the fluid ejection event, after the fluid ejection event, or combinations thereof.

12. The method of claim 6, wherein the micro-fluidic channel fluidically coupling the fluid ejection chamber and the pump is formed with the microfluidic device in a u-shape, a w-shape, an m-shape, a T-shape, an I-shape, an S-shape, or combinations thereof.

13. A method of operating a microfluidic device, comprising:
activating a fluid ejection actuator to eject an amount of fluid from a fluid ejection chamber through a nozzle; and
activating a pump located within a micro-fluidic channel fluidically coupled to the fluid ejection actuator during a fluid ejection event to create a positive net flow from the pump to the fluid ejection chamber, the fluid ejection event comprising a plurality of ejections of fluid from the nozzle,
wherein a ratio of the frequency of the activation of the pump with respect to a frequency of the activation of the fluid ejection actuator is defined by an efficiency of the pump to compensate for air bubbles formed by activation of the fluid ejection actuator purged from the nozzle towards the pump and micro-recirculation design geometry of the micro-fluidic channel.

14. The method of claim 13, wherein the ratio of the frequency of the activation of the pump with respect to a frequency of the activation of the fluid ejection actuator is between 1000:1 and 1:1000.

15. The method of claim 13, wherein the pump is activated following activation of the fluid ejection actuator in a variable manner.
